(19) United States
(12) Patent Application Publication
(10) Pub. No.: US 2006/0004557 A1
(43) Pub. Date: Jan. 5, 2006

(54) System and method for reducing size of simulation value change files

(75) Inventors: Guillermo Maturana, Berkeley, CA (US); Melvin Cardozo, San Jose, CA (US); Mayank Gupta, Sunnyvale, CA (US); Alok Kuchlous, Sunnyvale, CA (US)

Correspondence Address: BEVER, HOFFMAN & HARMS, LLP, 1432 CONCANNON BLVD, BLDG G, LIVERMORE, CA, 94550-6006, US

(73) Assignee: Synopsys, Inc., Mountain View, CA (US)

(21) Appl. No.: 10/884,471

(22) Filed: Jul. 1, 2004

(51) Int. Cl. G06F 17/50

(52) U.S. Cl. 703/14

(57) ABSTRACT

During simulation of an IC design, traces of certain signals can be generated, thereby allowing defects in the design to be detected. The traces of these signals, i.e. the target set, are typically saved in a value change file. Unfortunately, this value change file can get very large, thereby causing capacity and performance problems. A technique is described in which a subset of signals that can regenerate the target set of signals is determined. Determining the subset of signals can include identifying state elements (e.g. edge-triggered devices) and corresponding signal dependencies of the IC design. Advantageously, only this subset of signals needs to be saved in the value change file, thereby significantly reducing its size. The target set of signals can be computed on demand after reading the value change file.

### BACKGROUND OF THE INVENTION

1. Field of the Invention

The present invention relates to a value change file used in the simulation of an integrated circuit design and, in particular, to reducing the size of the value change file by determining a subset of signals that can be used to regenerate a target set of signals.

2. Description of the Related Art

FIG. 1 shows a simplified representation of an exemplary design flow for an integrated circuit. At a high level, the process starts with the product idea (step 100) and is realized in an electronic design automation (EDA) software design process (step 110). When the integrated circuit design is finalized, it can be taped-out (step 140). After tape out, the fabrication process (step 150) and packaging and assembly processes (step 160) occur resulting, ultimately, in finished integrated circuits (result 170).

The EDA software design process (step 110) is actually composed of a number of steps 112-130, shown in linear fashion for simplicity. Note that in an actual design process, certain steps (or series of steps) may have to be repeated until any associated tests are passed. Similarly, in any actual design process, these steps may occur in different orders and combinations. This description is therefore provided by way of context and general explanation rather than as a specific, or recommended, design flow for a particular integrated circuit. A brief description of the components steps of the EDA software design process (step 110) will now be provided.

In a system design step 112, the designers describe the functionality that they want to implement and perform what-if planning to refine functionality, check costs, etc. Hardware-software architecture partitioning can occur at this stage. Exemplary EDA software products from Synopsys, Inc. that can be used in step 112 include Model Architect, Saber, System Studio, and DesignWare® tools.

In a logic design and functional verification step 114, the source code (e.g. VHDL or Verilog) for modules of the integrated circuit can be written and the design checked for functional accuracy. Specifically, the design can be checked to ensure that it produces the correct outputs. Exemplary EDA software products from Synopsys, Inc. that can be used in step 114 include VCS, VERA, DesignWare®, Magellan, Formality, ESP and LEDA tools.

In a synthesis and design for test step 116, the source code can be translated to a netlist, which is optimized for a target technology. Additionally, tests to permit checking of the finished chip can be generated and implemented. Exemplary EDA software products from Synopsys, Inc. that can be used in step 116 include Design Compiler®, Physical Compiler, Test Compiler, Power Compiler, FPGA Compiler, Tetramax, and DesignWare® tools.

In a design planning step 118, an overall floorplan for the chip can be constructed and analyzed for timing and top-level routing. Exemplary EDA software products from Synopsys, Inc. that can be used in step 118 include Jupiter and Flooplan Compiler tools.

In a netlist verification step 120, the netlist can be checked for compliance with timing constraints and for correspondence with the source code. Exemplary EDA software tools from Synopsys, Inc. that can be used in step 120 include VCS, VERA, Formality and PrimeTime tools.

In a physical implementation step 122, the placement (i.e. the positioning of circuit elements in the design) and the routing (i.e. the connection of those circuit elements) can be performed. Exemplary EDA software products from Synopsys, Inc. that can be used in step 122 include the Astro tool.

In an analysis and extraction step 124, the integrated circuit function can be verified at a transistor level, which in turn can permit what-if refinement. Exemplary EDA software products from Synopsys, Inc. that can be used in step 124 include the Star RC/XT, Raphael, and Aurora tools.

In a physical verification step 126, various checking functions can be performed to ensure correctness for manufacturing, electrical issues, lithographic issues, and circuitry. Exemplary EDA software products from Synopsys, Inc. that can be used in step 126 include the Hercules tool.

In a resolution enhancement step 128, the layout can be geometrically manipulated to improve the manufacturability of the design. Exemplary EDA software products from Synopsys, Inc. that can be used in step 128 include the iN-Phase, Proteus, and AFGen tools.

In a mask data preparation step 130, the “tape-out” data for producing the masks used to make the integrated circuit can be generated. Exemplary EDA software products from Synopsys, Inc. that can be used in step 130 include the CATS® family of tools.

During logic design and functional verification step 114, a simulator can document signal changes in the design, thereby allowing defects (also called bugs) in the design to be detected. These signal changes can be documented by generating a trace (i.e. a history) of the values held by signals during simulation. In typical embodiments, a user can select the traces to be captured. For example, in one embodiment, the user could select traces for all signals in a design. In another embodiment, the user could select traces for only certain signals in the design. These traces can be captured in a file, called a value change file.

As designs continue to increase in complexity, the corresponding value change files also increase in size. These large value change files can cause capacity problems (i.e. require an undesirably large storage space). Moreover, these large value change files can be very tedious and time-consuming to analyze during run time. To reduce value change file size, certain compression techniques can be used. Unfortunately, even with compression, capacity problems are still occurring with increasing frequency.

Therefore, a need arises for a technique of reducing the size of the value change files.

### SUMMARY OF THE INVENTION

During simulation of an integrated circuit design, a simulator can generate traces of certain signals, thereby allowing defects in the design to be detected. The traces of these signals, called a target set herein, are typically saved in a value change file. Unfortunately, this value change file can get very large, thereby causing capacity and performance problems.

In accordance with one aspect of the invention, a subset of signals that can regenerate the target set of signals is determined. Notably, only this subset of signals needs to be saved in the value change file, thereby significantly reducing its size. The target set of signals can be computed on demand after reading the value change file.

Determining the subset of signals can include identifying state elements (e.g. flip-flops, latches, or other storage devices) and corresponding signal dependencies of the integrated circuit design. In one embodiment, identifying the state elements can include all state elements of the integrated circuit design. In another embodiment, identifying the state elements can include a set of state elements of the integrated circuit design. Determining the subset of signals can occur during a compile time of the simulation.

Generating the subset of signals can include using the corresponding signal dependencies of the integrated circuit design. In one embodiment, generating the subset of signals can include correlating the corresponding signal dependencies to an equation table. In another embodiment, generating the subset of signals can include encoding the corresponding signal dependencies. In yet another embodiment, generating the subset of signals includes compressing the subset. Generating the subset of signals can occur during a run time of the simulation.

Regenerating the target set of signals can include initializing the state elements and then advancing by clock cycles to regenerate the target set of signals. In one embodiment, regenerating the target set of signals can include decompressing the subset of signals. Regenerating the target set of signals can occur during an analysis time.

A value change file for an integrated circuit design is also described. The value change file can include traces for a plurality of state elements. In one embodiment, the value change file can further include at least one signal dependency. In another embodiment, the signal dependencies can be stored in a separate file or executable. Advantageously, a target set of signals can be regenerated using these traces and the signal dependencies.

A computer-implemented software tool for performing a simulation on an integrated circuit design is also described. The software tool can include code for determining a subset of signals and corresponding signal dependencies that can regenerate a target set of signals, code for generating the subset of signals, code for regenerating the target set of signals using the subset of signals and corresponding signal dependencies, and code for analyzing the target set of signals.

### BRIEF DESCRIPTION OF THE FIGURES

FIG. 1 shows a simplified representation of an exemplary design flow.

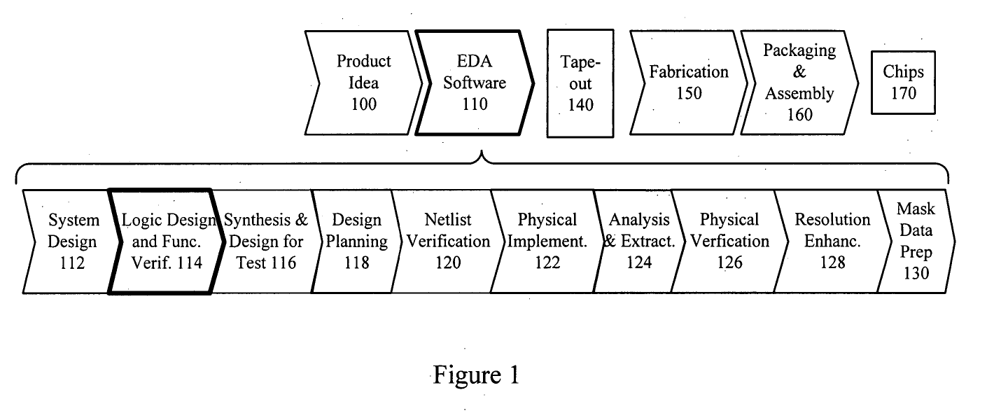

FIG. 2 illustrates a value change file size reduction technique that can use state elements and signal dependencies.

### DETAILED DESCRIPTION OF THE FIGURES

In accordance with one aspect of the invention, providing a subset of signals can significantly reduced the number of signals typically provided in a value change file. Advantageously, the subset of signals can regenerate a target set by using state elements (e.g. flip-flops or any other edge-triggered devices) and signal dependencies. Specifically, any signal that can be computationally derived from values stored by a set of state elements can be regenerated using the values of the signals in those state elements and the corresponding signal dependency.

For example, assume that a signal C of a design is computed by performing a logic AND operation using signals A and B, wherein signals A and B are provided by state elements. In this case, to regenerate a target set including signals A, B, and C, the value change file can include traces of signals A and B as well as a signal dependency to compute C, i.e. A AND B=C. Using signal regeneration in this example could reduce storage by approximately 30% (i.e. traces for the values of signals A and B, but not signal C, can be stored in the value change file).

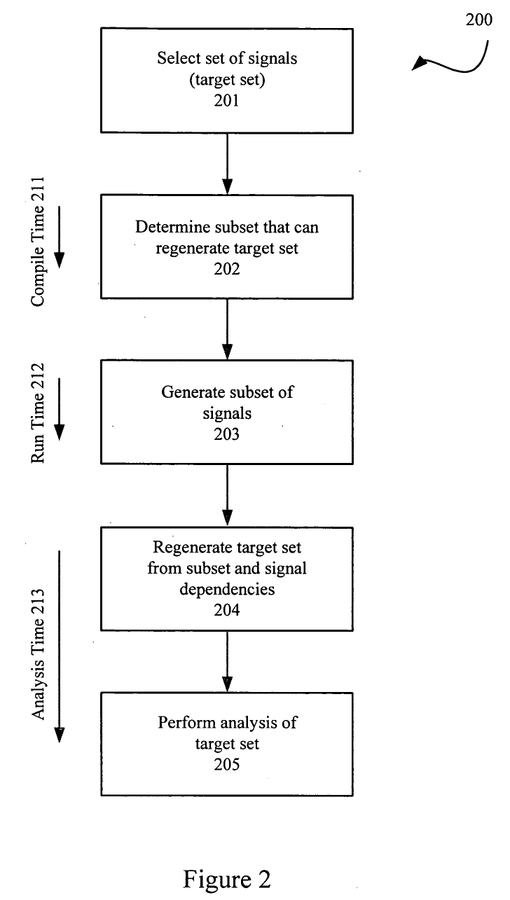

FIG. 2 illustrates a value change file size reduction technique 200 that can use state elements and signal dependencies. In step 201, a user selects a set of signals, called a target set. In one embodiment, the user can specify the target set in the source code for the simulator. The simulator can read the directives in this source code (e.g. dump any values of signals downstream of node N in the hierarchy, dump values of signals X, Y, Z . . . , or dump values of all signals, etc.) during simulation. Advantageously, the subsequent steps that perform the value change file size reduction, i.e. steps 202-204, can be transparent to the user, thereby maintaining a simple user interface.

In step 202, a subset of signals that can regenerate the target set can be determined. This determination can take into account both state elements and corresponding signal dependencies. A compiler in the simulator can perform step 202 during a compile time 211. In one embodiment of step 202, a set of state elements can be identified, wherein the set of state elements is less than all the state elements in the design. This set of state elements could be determined by some optimization identifiable using the compiler. In another more aggressive embodiment of step 202, all the state elements in the design can be identified.

In step 203, the subset of signals can be generated. The simulator can perform step 203 during a run time 212. The resulting subset can be optionally compressed using any compression technique. In one embodiment, the corresponding signal dependencies could be generated by the simulator and then encoded. In another embodiment, the corresponding signal dependencies could be correlated to an equation of an equation table.

Generating this subset of signals can dramatically decrease the size of the value change file. For example, the reduced file size of the subset as a fraction of the target set size can range from approximately 2% to 36%. Logically, the amount of reduction depends on the number of signals that can be regenerated. In general, a design including a significant amount of combinational logic can result in a smaller subset (and hence a smaller value change file) than another design including less combinational logic.

Note that the subset determination and target set regeneration of steps 202 and 203, respectively, can advantageously replace a conventional “dump” step (i.e. creating a standard value change file). A conventional dump step for a design including at least a million signals (which is becoming more the rule than the exception) can significantly slow down the run time of the simulator. Notably, the above-described subset generation and target set regeneration can significantly reduce run time 212. In some examples, this reduction can be from 32% to 48% of the original run time.

In step 204, the target set can be regenerated using the subset (which is decompressed, as necessary) and the corresponding signal dependencies. Note that step 204 can begin by initializing the state elements of the design and then advancing by clock cycles to regenerate the target set. The simulator can perform step 204 during an analysis time 213. In one embodiment, the VCS simulator, licensed by Synopsys, Inc., can implement steps 202-204 of FIG. 2.

Note that because of target regeneration (step 204), analysis time 213 will take longer compared to a conventional analysis time. However, the additional time for analysis time 213 is more than compensated for by the time saved in run time 212 compared to a conventional run time. Therefore, a combined run/analysis time using target regeneration can still be considerably faster than a conventional combined run/analysis time.

Once the target set is regenerated, standard analysis of the target set can be performed in step 205.

Although illustrative embodiments of the invention have been described in detail herein with reference to the figures, it is to be understood that the invention is not limited to those precise embodiments. They are not intended to be exhaustive or to limit the invention to the precise forms disclosed. For example, other embodiments may utilize different techniques to generate the subset of signals and/or to encode the dependencies required to regenerate the target set.

Many modifications and variations of the above-described value change file will be apparent. Accordingly, it is intended that the scope of the invention be defined by the following claims and their equivalents.

1. A method of facilitating an efficient simulation on an integrated circuit design, the method comprising:
determining a subset of signals that can regenerate a target set of signals;
generating the subset of signals; and
regenerating the target set of signals using the subset of signals.

2. The method of claim 1, wherein a user selects the target set of signals.

3. The method of claim 1, wherein determining the subset of signals includes identifying state elements and signal dependencies of the integrated circuit design.

4. The method of claim 3, wherein identifying state elements includes all state elements of the integrated circuit design.

5. The method of claim 3, wherein identifying state elements includes a set of state elements of the integrated circuit design.

6. The method of claim 3, wherein determining the subset of signals occurs during a compile time of the simulation.

7. The method of claim 3, wherein generating the subset of signals occurs during a run time of the simulation.

8. The method of claim 3, wherein generating the subset of signals includes compressing the subset.

9. The method of claim 3, wherein generating the subset of signals includes correlating corresponding signal dependencies of the integrated circuit design to an equation table.

10. The method of claim 3, wherein generating the subset of signals includes encoding corresponding signal dependencies of the integrated circuit design.

11. The method of claim 3, wherein generating the subset of signals includes using corresponding signal dependencies of the integrated circuit design.

12. The method of claim 11, wherein regenerating the target set of signals includes decompressing the subset of signals.

13. The method of claim 11, wherein regenerating the target set of signals includes initializing the state elements and then advancing by clock cycles to regenerate the target set of signals.

14. The method of claim 11, wherein regenerating the target set of signals occurs during an analysis time.

15. A method of reducing a size of a value change file for simulating an integrated circuit design, the method comprising:
determining a subset of signals that can regenerate a target set of signals by identifying state elements and signal dependencies of the integrated circuit design; and
saving the subset of signals in the value change file.

16. The method of claim 15, wherein identifying state elements includes all state elements of the integrated circuit design.

17. The method of claim 15, wherein identifying state elements includes a set of state elements of the integrated circuit design.

18. The method of claim 15, wherein saving the subset of signals includes compressing the subset of signals.

19. The method of claim 15, wherein saving the subset of signals includes correlating corresponding signal dependencies of the integrated circuit design to an equation table.

20. The method of claim 15, wherein saving the subset of signals includes encoding corresponding signal dependencies of the integrated circuit design.

21. A method of creating a target set of signals for simulating an integrated circuit design, the method comprising:
regenerating the target set of signals using a subset of signals and signal dependencies of the integrated circuit design.

22. The method of claim 21, further including decompressing the subset of signals before using the subset of signals.

23. The method of claim 21, wherein regenerating the target set of signals includes initializing state elements and then advancing by clock cycles.

24. A value change file for an integrated circuit design, the value change file comprising:
traces for a plurality of state elements; and
at least one signal dependency, wherein a target set of signals can be regenerated using the plurality of state elements and the at least one signal dependency.

25. A computer-implemented software tool for performing a simulation on an integrated circuit design, the software tool including:
code for determining a subset of signals and corresponding signal dependencies that can regenerate a target set of signals;
code for generating the subset of signals;
code for regenerating the target set of signals using the subset of signals and corresponding signal dependencies; and
code for analyzing the target set of signals.
